(19) United States
(12) Patent Application Publication
(10) Pub. No.: US 2010/0124684 A1
(43) Pub. Date: May 20, 2010

(54) HEATING DEVICE OF METALLIC INTERCONNECT FOR SOLID OXIDE FUEL CELL AND COATING METHOD OF THE INTERCONNECT USING THE SAME

(75) Inventors: Rak-Hyun Song, Daejeon (KR); Dong-Ryul Shin, Daejeon (KR); Tak-Hyung Lim, Daejeon (KR); Seung-Bok Lee, Seoul (KR); Young-Sung Yoo, Daejeon (KR); Jong-Eun Hong, Daejeon (KR); Seong-Soo Pyo, Seoul (KR)

Correspondence Address: LAW OFFICE OF DELIO & PETERSON, LLC., 121 WHITNEY AVENUE, 3RD FLLOR, NEW HAVEN, CT, 06510, US

(73) Assignee: KOREA INSTITUTE OF ENERGY RESEARCH, Yuseong-gu (KR)

(21) Appl. No.: 12/618,038

(22) Filed: Nov. 13, 2009

(30) Foreign Application Priority Data
Nov. 14, 2008 (KR) 10-2008-0113155

(51) Int. Cl. H01M 8/04; H01M 2/24

(52) U.S. Cl. 429/26; 427/446

(57) ABSTRACT

Disclosed is a method for heating a metallic interconnect for a solid oxide fuel cell (SOFC) to 150˜300° C., which can minimize the thermal shock by reducing a temperature difference between the metallic interconnect and a coating material during a thermal plasma coating process on the metallic interconnect for the SOFC. Accordingly, through the disclosed method, a densified coating layer with minimized micro pores/cracks can be formed on the surface of the metallic interconnect. Thus, it is possible to reduce the loss in output performance during the operation of the SOFC at a high temperature, and to maintain the long-term durability and performance of the metallic interconnect.

### BACKGROUND OF THE INVENTION

1. Field of the Invention

The present invention relates to a thermal plasma coating method of a metallic interconnect for a solid oxide fuel cell (SOFC). More particularly, the present invention relates to a heating device of a metallic interconnect, and a method for carrying out thermal plasma coating of the metallic interconnect by using the same, in which when a thermal plasma coating process is used to coat the metallic interconnect for the SOFC with a conductive coating material, a thermal shock caused by a temperature difference between the metallic interconnect and the coating material can be reduced.

2. Description of the Prior Art

As power demands show a tendency to gradually increase according to a recent industrial development and economic growth, environmental problems, including air pollution and earth shock, have seriously arisen by the use of fossil fuels (such as petroleum, or coal) required for power production. Especially, since the exhaust of carbon dioxide by the use of fossil fuels is pointed out as a main factor of global warming and various kinds of environmental pollution, the development of solar light/heat energy, bio energy, wind energy, and hydrogen energy, as clean energy sources substituting for the fossil fuels, is being actively conducted.

From among such clean energy sources, research on the field of fuel cells using a hydrogen fuel is active. A fuel cell technology is considered as a future electricity generation technology because a fuel cell does not exhaust pollutants in electricity generation, and has an advantage in that it does not require a site for a power plant, a power transmission facility, or a substation.

The fuel cell is divided into a phosphoric acid fuel cell (PAFC), a molten carbonate fuel cell (MCFC), a solid acid oxide fuel cell (SOFC), a solid polymer electrolyte fuel cell (a polymer electrolyte fuel cell (PEFC) or a proton exchange membrane fuel cell (PEMFC)), according to the type of electrolyte. Herein, the phosphoric acid fuel cell has an operating temperature of about 200° C., the molten carbonate fuel cell has about 650° C., the solid oxide fuel cell has about 1000° C., and the solid polymer electrolyte fuel cell has an operating temperature around 80° C.

The SOFC, from among the cells, employs a solid oxide having oxygen ion conductivity as an electrolyte. Thus, the SOFC has an advantage in that it has the highest efficiency as a fuel cell, can improve the efficiency by up to 85%, due to inclusion of the heat generated by cogeneration with a gas turbine, and can use various fuels. Also, since the electrolyte for the SOFC is in a solid state, there is no loss in the electrolyte and thus no need to supplement the electrolyte. Besides, there is no need to use a noble metal catalyst, and it is easy to supply a fuel through direct internal reforming.

The output performance of a unit cell of such an SOFC is reduced by various factors, such as polarization loss. Also, when a plurality of unit cells of the SOFC are layered between a separator, the output performance is influenced by the contact resistance between the separator and the cells.

At present, as a material of a metallic interconnect for the SOFC, a stainless steel, such as STS430, and STS444, is used. Also, a newly developed Crofer 22 APU may be used. However, by these materials, it is very difficult to achieve the durability of up to 40000 hours required for commercialization, and thus there is need to develop a novel alloy and to research a technology for coating a conductive ceramic on the surface of a conventional material.

A method for coating a conductive ceramic on a metallic interconnect for an SOFC includes wet spray coating, thermal plasma process, electroplating, CVD, PVD, or the like.

Especially, the thermal plasma process, which has been recently attempted, is a coating process using high temperature plasma. There is a problem in that micro-cracks and micro-pores are formed on a coating layer by a thermal shock caused by a temperature difference between a metallic interconnect (substrate) and a coating material during coating. Thus, research to solve this problem is required.

### SUMMARY OF THE INVENTION

Accordingly, the present invention has been made to solve the above-mentioned problems occurring in the prior art, and the present invention provides a heating device of a metallic interconnect for a solid oxide fuel cell (SOFC), and a method for carrying out thermal plasma coating of the metallic interconnect for the SOFC by using the same, in which when the metallic interconnect for the SOFC is coated by thermal plasma, a temperature difference between the metallic interconnect (substrate) and a high temperature coating material is reduced so as to minimize a thermal shock and thereby to form a densified coating layer.

In accordance with an aspect of the present invention, there is provided a heating device for a metallic interconnect for a SOFC, the heating device comprising: a heating plate for heating the metallic interconnect for the SOFC to 150˜300° C., the heating plate being a flat type plate on which the metallic interconnect is seated; a heating means comprising a heater for providing heat to the heating plate, and a controller for controlling a heating temperature of the heater, the heater being disposed at an undersurface portion of the heating plate; a heat-insulating member, for insulating the heater's portions not in contact with the heating plate, at an undersurface portion of the heater; a case for housing the heating plate, the heater, and the heat-insulating member; and a clamp for fixing the metallic interconnect on the heating plate, the clamp being provided at outside of the case.

Between the heater and the heat-insulating member, a heater auxiliary panel for allowing the heat to be transferred from the heater to the heating plate with a uniform temperature gradient may be further provided.

Also, in accordance with another aspect of the present invention, there is provided a method for carrying out thermal plasma coating of a metallic interconnect for an SOFC by using the heating device, the method comprising the steps of: disposing the metallic interconnect on a heating plate provided in the heating device; and heating the metallic interconnect to a temperature of 150˜300° C. by the heating plate while spraying thermal plasma on a surface of the metallic interconnect under an inert gas atmosphere to coat the surface with a conductive coating material.

The thermal plasma is preferably sprayed by a spray gun moving at a rate of 300˜400 mm/s, the spray gun being disposed 100˜200 mm apart from the metallic interconnect.

According to the above described configuration of the present invention, in a thermal plasma coating process on a metallic interconnect for an SOFC, a temperature difference between the metallic interconnect and a coating material is reduced. This minimizes a thermal shock.

Accordingly, a densified coating layer with minimized micro pores/cracks is formed on the surface of the metallic interconnect. Also, it is possible to reduce the loss in output performance during the operation of the SOFC at a high temperature, and to maintain the long-term durability and performance of the metallic interconnect.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a metallic interconnect for a solid oxide fuel cell (SOFC) to which a heating device according to the present invention is applied;

FIG. 2 is a perspective view illustrating an embodiment of a heating device of a metallic interconnect for an SOFC, according the present invention;

FIG. 3a is an electron microscopic photograph showing a coating layer of a metallic interconnect after a thermal plasma coating process, in a state where the metallic interconnect was not heated;

FIG. 3b is an electron microscopic photograph showing a coating layer of a metallic interconnect after a thermal plasma coating process, in a state where the metallic interconnect was heated by the coating method according to the present invention; and

FIG. 4 is a graph showing the electrical property of a metallic interconnect applied with a coating method according to the present invention, which was tested at a high temperature.

### DETAILED DESCRIPTION OF THE EXEMPLARY EMBODIMENTS

Hereinafter, an exemplary embodiment of the present invention will be described with reference to the accompanying drawings. It is to be understood, however, that the following embodiment is illustrative only, and the scope of the present invention is not limited thereto. Also, those skilled in the art will appreciate that various modifications, additions and substitutions are possible.

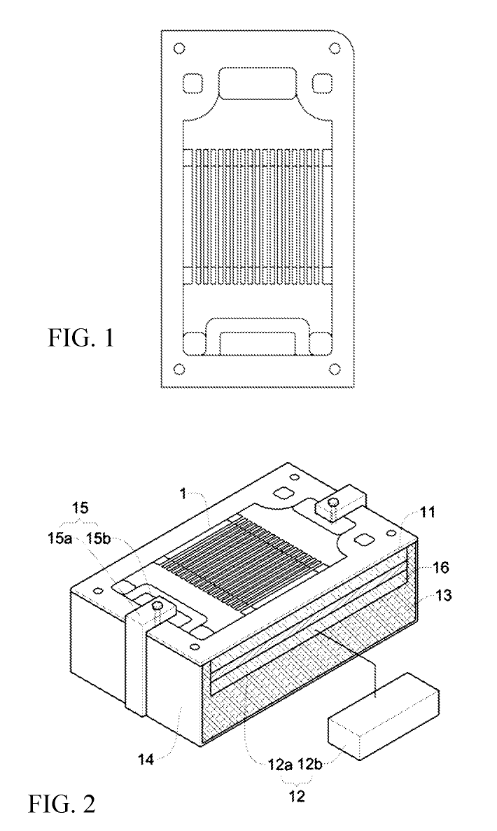

FIG. 1 illustrates a metallic interconnect for a solid oxide fuel cell (SOFC) to which a heating device according to the present invention is applied, in which a metallic interconnect 1 is subjected to machining and surface-treatment, and then the surface of the metallic interconnect 1 is coated with a conductive material (e.g. a conductive ceramic) by a coating process, such as a thermal plasma process.

The shape and size of the metallic interconnect 1 are configured by machining. In the surface treatment, a sandblaster is used to give roughness to the surface of the metallic interconnect 1 by a blast material with a particle size of 15˜45 μm, such as aluminum oxide (Al₂O₃), so as to increase the surface area of the metallic interconnect 1 and thereby to improve the adhesive force of the metallic interconnect 1 and the coating material during coating.

FIG. 2 is a perspective view illustrating an embodiment of a heating device according the present invention, the heating device being designed to be used for a thermal plasma coating process on the above described surface-treated metallic interconnect 1.

As shown in FIG. 2, the heating device according to the present embodiment, includes: a heating plate 11 for heating the metallic interconnect 1; a heating means 12 for providing heat to the heating plate 11; a heat-insulating member 13 for intercepting heat transmission to any portions other than the heating plate 11; a case 14 for housing the above mentioned components; and a clamp 15 for fixing the metallic interconnect 1 on the heating plate 11, which is provided in the case 14. Hereinafter, each of the components will be described in detail.

The heating plate 11 is a flat type plate larger than the metallic interconnect 1 (for the SOFC) having a size of about 150×200 mm, so that the metallic interconnect 1 can be seated in the heating plate 11. The heating plate 11 is manufactured by stainless steel, such as SUS430, or the like, and the metallic interconnect 1 is heated to a temperature of 150˜300° C.

The heating means 12 includes a heater 12a and a general controller 12b for controlling the heater 12a. Herein, the heater 12a has a plate structure including a resistor, such as SiC (Silicon Carbide), and heats the heating plate 11 in a state where it is brought into contact with the undersurface of the heating plate 11. The controller 12b controls the heating temperature of the heater 12a, and more particularly controls the heating/cooling limit of the heater 12a in such a manner that the heating temperature of the metallic interconnect 1 by the heating plate 11 is not out of temperature range of 150˜300° C.

The heat-insulating member 13, at the undersurface of the heater 12a, insulates heater portions not in contact with the heating plate 11, such as the undersurface or lateral surface of the heater 12a. Preferably, the heat-insulating member 13 includes general refractory bricks, and is constructed with an appropriate height and an appropriate area in consideration of the position of a thermal plasma coating device.

The case 14 houses the above described heating plate 11 and the heater 12a, and the heat-insulating member 13, and is preferably made of a metallic material having stability and robustness so that the clamp 15 described below can strongly fix the metallic interconnect 1.

At the outside of the case 14, that is, at left/right side ends of the case, a pair of clamps 15 are provided to perform a role of fixing the metallic interconnect 1 on the heating plate 11. The clamp 15 includes: a bracket 15a, which has a structure where it perpendicularly extends from the lateral wall of the case 14, and horizontally bends over the edge portion of the heating plate 11; and a bolt 15b fastened to the horizontal portion of the bracket 15a, which vertically operates against the edge portion of the heating plate 11. Accordingly, in a state where the metallic interconnect 1 is placed on the heating plate 11, the fastening or unfastening of the bolt 15b assembled to the bracket 15a allows the metallic interconnect 1 to be strongly fixed on the heating plate 11 or to be free from the heating plate 11.

Meanwhile, between the heater 12a and the heat-insulating member 13, a heater auxiliary panel 16 may be further provided so that the heat can be transferred from the heater 12a to the heating plate 11 with a uniform temperature gradient. Like the heating plate 11, the heater auxiliary panel 16 is made of stainless steel, such as SUS430, or the like.

Hereinafter, the thermal plasma coating method of the metallic interconnect 1 by the metallic interconnect heating device configured as described above, according the present invention, will be described.

First, a metallic interconnect 1 is strongly fixedly disposed on the heating plate 11 provided in the heating device. Then, the metallic interconnect 1 is heated to 150˜300° C. through the heating plate 11 by operating the heating means 12 of the heating device. When the heating temperature of the heating plate 11 is out of the temperature range of 150˜300° C., micro-cracks or micro-pores occur on a coating layer by thermal plasma. Such micro-cracks or micro-pores are not appropriate for oxidation resistant coating of the metallic interconnect 1. Since SOFC operates at a high temperature range (600˜800° C.), it is very important to inhibit high temperature corrosion of the metallic interconnect 1. Accordingly, the coating layer is required to be densified so that the corrosion rate can be reduced by blocking oxygen diffused from the outside and the movement of elements volatilized from a deteriorated metal can be inhibited. Thus, the heating temperature of the metallic interconnect 1 has to satisfy the above mentioned temperature range.

Meanwhile, in order to inhibit a chemical reaction, such as oxidation, during a thermal plasma coating process on the metallic interconnect 1, a conventional gas supplying means (not shown) for forming an inert gas atmosphere is disposed at the outside of the heating device. In the supply of the inert gas from the gas supplying means, argon (Ar) is preferably supplied at 30˜40 l/min, and helium (He) is supplied at 35˜45 l/min.

Also, above the metallic interconnect 1, a spray gun (not shown) for spraying thermal plasma on the surface of the metallic interconnect 1 is disposed. The spray gun is disposed 100˜200 mm apart from the metallic interconnect 1, and moves at a rate of 300˜400 mm/s while spraying thermal plasma. The reason why the space between the spray gun and the metallic interconnect 1, and the moving rate of the spray gun, are limited to the above mentioned ranges, is that the ranges were determined, through repetitive tests, to be most appropriate for uniform and stable coating of a coating material on the surface of the metallic interconnect 1.

As described above, in the present invention, while the metallic interconnect 1 is heated to a temperature of 150˜300° C. by the heating plate 11, thermal plasma is sprayed on the surface of the metallic interconnect 1 under the inert gas atmosphere to coat the surface with a conductive coating material. Herein, the conductive coating material includes (La_{0.8}Sr_{0.2})MnO₃, or the like.

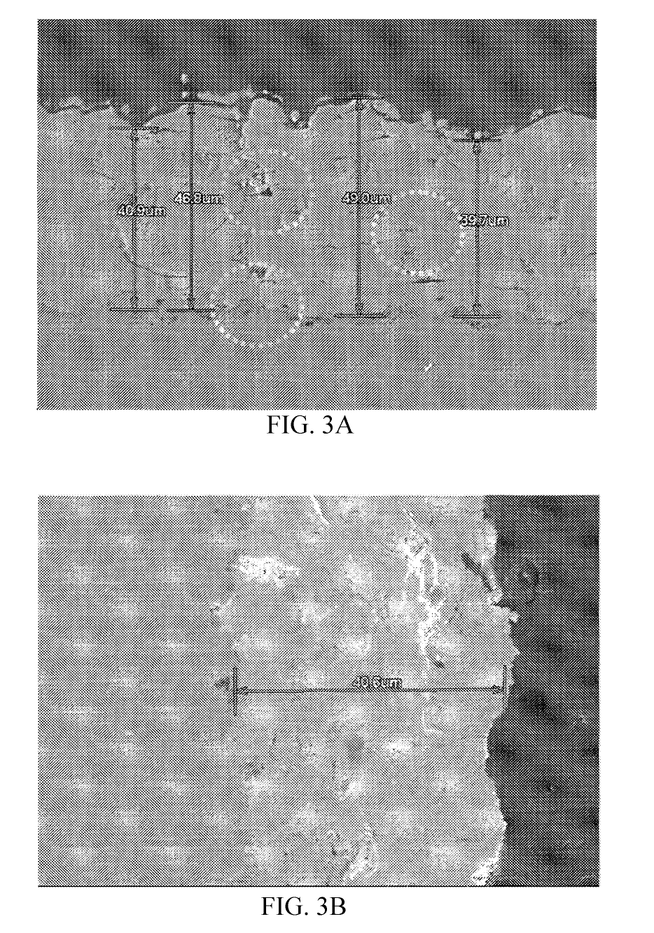

FIG. 3a is an electron microscopic photograph showing a coating layer of a metallic interconnect after a thermal plasma coating process, in a state where the metallic interconnect was not heated, and FIG. 3b is an electron microscopic photograph showing a coating layer of a metallic interconnect after a thermal plasma coating process, in a state where the metallic interconnect was heated by the coating method according to the present invention.

As it can be seen from FIG. 3a, in a state where the metallic interconnect was not heated, when the thermal plasma coating process was performed, micro pores and cracks occurred.

Meanwhile, as it can be seen from FIG. 3b, in a state where the metallic interconnect was heated according to the present invention, when the thermal plasma coating process was performed, a defect in the coating layer was significantly reduced.

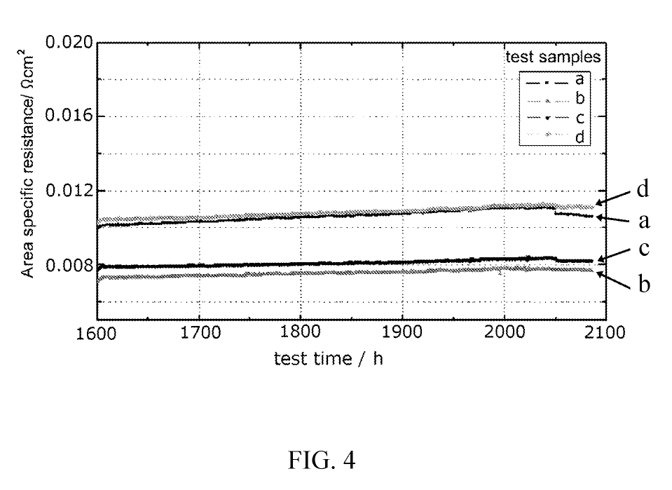

FIG. 4 is a graph showing the electrical property of a metallic interconnect applied with a coating method according to the present invention, which was tested at a high temperature.

Under the condition where the metallic interconnect was heated, when the surface of the metallic interconnect was coated with (La_{0.8}Sr_{0.2})MnO₃ (a conductive coating material) by a thermal plasma coating process, it can be determined that test samples a˜d have low area specific resistance values of 7˜10 mΩcm² for about 2000 hours during a high temperature durability test.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A heating device for a metallic interconnect for a solid oxide fuel cell (SOFC), the heating device comprising:
a heating plate for heating the metallic interconnect for the SOFC to 150˜300° C., the heating plate being a flat type plate on which the metallic interconnect is seated;
a heating means comprising a heater for providing heat to the heating plate, and a controller for controlling a heating temperature of the heater, the heater being disposed at an undersurface portion of the heating plate;
a heat-insulating member, for insulating the heater's portions not in contact with the heating plate, at an undersurface portion of the heater;
a case for housing the heating plate, the heater, and the heat-insulating member; and
a clamp for fixing the metallic interconnect on the heating plate, the clamp being provided at outside of the case.

2. The heating device as claimed in claim 1, further comprising a heater auxiliary panel for allowing the heat to be transferred from the heater to the heating plate with a uniform temperature gradient, the heater auxiliary panel being disposed between the heater and the heat-insulating member.

3. A method for carrying out thermal plasma coating of a metallic interconnect for an SOFC by using the heating device as claimed in claim 1, the method comprising the steps of:
disposing the metallic interconnect on a heating plate provided in the heating device; and
heating the metallic interconnect to a temperature of 150˜300° C. by the heating plate while spraying thermal plasma on a surface of the metallic interconnect under an inert gas atmosphere to coat the surface with a conductive coating material.

4. The method as claimed in claim 3, wherein the thermal plasma is sprayed by a spray gun moving at a rate of 300˜400 mm/s, the spray gun being disposed 100˜200 mm apart from the metallic interconnect.
